(19) United States
(12) Patent Application Publication
(10) Pub. No.: US 2015/0294240 A1
(43) Pub. Date: Oct. 15, 2015

(54) SYSTEMS AND METHOD FOR IMPLEMENTING TOUR EVENT COMPARISON

(71) Applicant: Adam Farhi, Tel Aviv (IL)

(72) Inventor: Adam Farhi, Tel Aviv (IL)

(21) Appl. No.: 14/251,342

(22) Filed: Apr. 11, 2014

(51) Int. Cl. G06Q 10/02; G06Q 30/06

(52) U.S. Cl. CPC G06Q 10/025; G06Q 30/0623; G06Q 30/0631

(57) ABSTRACT

A system or method may be provided to compare the overall costs for attending different events in a tour. In particular, each overall cost may include admission cost, travel cost, and lodging cost. Further, the overall costs for different users who are planning to attend an event together as a group also are estimated. The users in the group may be located at different locations. Thus, overall costs for attending different events in a tour may be compared among different events of the tour and/or among different users in the group. In an embodiment, an event that results in a minimum aggregate cost for the group is selected and recommended to the group. In another embodiment, an event may be selected to balance the overall cost among the users in the group.

### BACKGROUND

1. Field of the Invention

The present invention generally relates to systems and methods for implementing tour event comparison.

2. Related Art

With modern technology, consumers have access to various marketplaces and merchants to make purchases. For example, event tickets for entertainment or sporting events are made available to consumers via not only brick-and-mortar stores but also online stores. Some events are related to a tour in which a series of similar events are held at various locations. As such, consumers may choose which one of the events in the tour to attend. In addition to the cost of admission, consumers may need to consider traveling and/or lodging costs at different regions of the country. Thus, there is a need for a system or method that helps facilitate comprehensive comparison among various events in a tour.

### BRIEF DESCRIPTION OF THE FIGURES

FIG. 1 is a block diagram of a networked system suitable for implementing a process for tour event comparison according to an embodiment.

FIG. 2 is a flowchart showing a process for tour event comparison according to one embodiment.

FIG. 3 is a diagram showing different event locations of a tour with respect to consumers' locations according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method may be provided to compare the overall desirability and costs for attending different events in a tour. In particular, the overall cost may include admission cost, travel cost, and lodging cost. Further, the overall costs for different users who are planning to attend an event together as a group may also be estimated. The users in the group may be located at different locations. Thus, overall costs for attending different events in a tour may be compared among different events of the tour and among different users in the group. In an embodiment, an event that results in a minimum aggregate cost for the group is selected and recommended to the group. In another embodiment, an event may be selected to balance the overall costs among the users in the group. In another embodiment, non-monetary factors may be analyzed to determine the “best” event for the user or group. For example, a user or group may want one or more friends or family local to an event that is not local for the user to attend the event. As such, depending on various factors, such as availability, convenience, costs, etc., an event may be suggested to the user or group that is not local to the user or group and actually costs more than attending the local event.

In an embodiment, the travel cost may be determined based on a user's travel preferences. The user's travel preferences may include preferences for different modes of transportation, such as by car, by airplane, by train, by bus, by ferry, and the like. Further, the admission cost may be determined based on a user's seating preference at the event. The lodging cost may be determined based on a user's lodging preference for a preferred category of lodging options, such as star rating of hotels, type of hotels, lodging amenities, and the like. A group preference for sharing means of travel or lodging also may be used to estimate the overall cost for a group.

The overall costs for different events in a tour may be presented in a comparison table to the user. The table may include an estimated cost for each combination of user and event. In an embodiment, a map may be used to present different locations of the events in the tour and different locations of users in the group. Thus, maps or graphs may be presented to the user or the group to facilitate selection of an event from the tour. In some embodiments, a communication tool may be provided to facilitate real time communication among the users in the group to facilitate selection of an event from the tour.

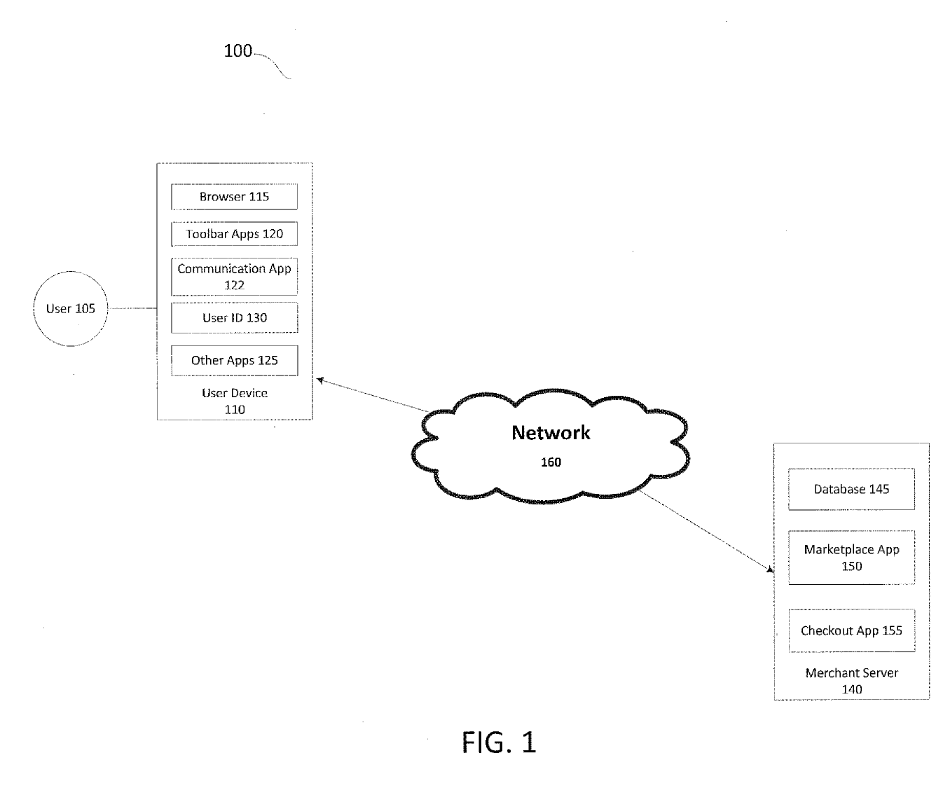

FIG. 1 is a block diagram of a networked system 100 suitable for implementing a process for facilitating a ticket purchase according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110 and a merchant server 140 in communication over a network 160, Merchant server 140 may be maintained by a ticket exchange service provider, such as StubHub, Inc. of San Francisco, Calif. A user 105, such as a sender or consumer, may utilize user device 110 to search and purchase event tickets using merchant server 140. A user 105 may utilize user device 110 to browse, find, and pay for a ticket using merchant server 140. For example, a ticket purchase application provided by the ticket exchange service provider may be installed at user device 110 to facilitate ticket purchase by connecting user device 110 to merchant device 110 via network 160. Further, user 105 may compare ticket prices for various events within a tour. Comprehensive cost comparison also may be implemented to compare travel and/or lodging costs for various events of a tour.

User device 110 and merchant server 140 each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by the ticket exchange service provider to associate user 105 with a particular account maintained by the ticket exchange service provider. A communications application 122, with associated interfaces, enables user device 110 to communicate within system 100.

User device 110 also may include an operating system that monitors and/or detect user interactions. For example, user device 110 may include a touch screen that displays information to user 105 and receives user input from user 105. User device 110 may monitor user input on the touch screen and may recognize user inputs that activate certain functions, e.g., purchase transactions.

User derive 110 also may collect location data using Global Positioning System (GPS) to identify a location of user device 110. Other means for collecting location data, such as WiFi devices, Near-Field Communication (NFC) devices, or the like also may be included in user device 110 for determining a location of user device 110. Thus, user device 110 may determine a current location of user device 110 based on the collected location data. In another embodiment, user device 110 may send the location data to merchant server 140 and merchant server 140 may determine a current location of user device 110 based on the location data.

Merchant server 140 may be maintained, for example, by a ticket exchange service provider offering various event tickets. The ticket exchange service provider may have a physical point-of-sale (POS) store front and/or an online store. The ticket exchange service provider merchant may provide a marketplace for facilitating buying and selling of various event tickets between buyers and sellers.

Merchant server 140 may include a database 145 identifying available event tickets, which may be made available for viewing and purchase by user 105. Merchant server 140 may associate events that belong to a tour. For example, a performer or a performing group may have a concert tour including a plurality of events at various locations. Merchant server 140 may store a tour schedule indicating the locations and dates/time of the events of the tour. Merchant server 140 also may include a marketplace application 150 which may be configured to serve information over network 160 to browser 115 of user device 110. In one embodiment, user 105 may interact with marketplace application 150 through browser 115 or ticket purchase application over network 160 in order to view various event tickets identified in database 145.

Merchant server 140 also may include a checkout application 155 which may be configured to facilitate the purchase by user 105 of event tickets. Checkout application 155 may be configured to accept payment information from or on behalf of user 105 through a payment service provider over network 160. For example, checkout application 155 may receive and process a payment confirmation from the payment service provider, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

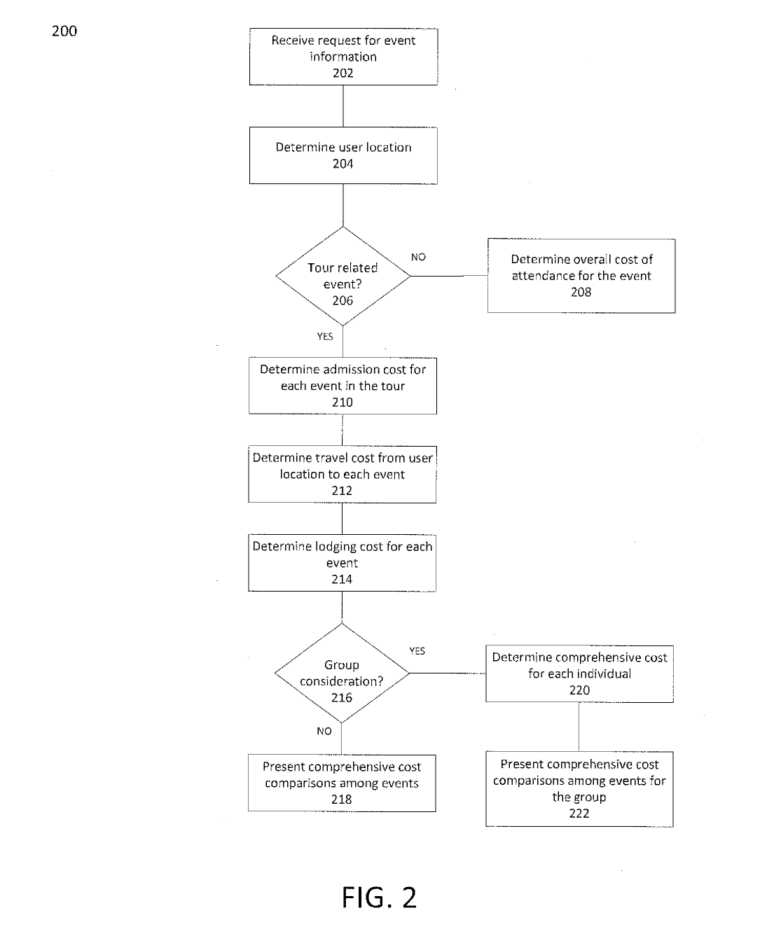

FIG. 2 is a flowchart showing a process 200 for implementing tour event comparison according to one embodiment. At step 202, merchant server 140 may receive request from user 105 for event information. For example, user 105 may operate user device 110 to execute a ticket exchange service application at user device 110 to find a ticket to an event. User 105 may enter a search query for a particular tour, performer's name, event name, or the like to find related events. In response, merchant server 140 may search in database 145 for related events. In particular, events with available seats or tickets may be presented to user 105 at user device 110.

At step 204, merchant server 140 may determine user 105's location based on user 105's GPS coordinates. For example, user device 110 may include a GPS device configured to detect a location of user device 110. Other techniques for location detection, such as Near Field Communication (NFC), location beacons, or the like, also may be used to detect user device 110's location. Based on the location of user 105, events located closest to user 105 may be presented to user 105. User 105 may select one of the events from the search result to view additional information of the selected event.

In an embodiment, user 105 may select a specific location, which can be local to the user or at another location the user either intends to be in or has a desire to be in. For example, the user may have a business trip planned and has time to go to an event at the business location. In another example, the user may have a lot of friends interested in a particular event at a location of the friends, such that the user may wish to join his/her friends at their location to attend an event.

In another embodiment, user 105's calendar or schedule may be accessed to determine user 105's expected location with respect to the event dates. For example, user 105 may plan to travel to another city next month and an event may occur at that city when user 105 will be visiting the city. Thus, events may be selected based on user 105's expected travel schedule.

At step 206, merchant server 140 may determine whether the selected event is related to a tour. For example, a performer or a performing group may offer a concert tour including a series of concerts in different cities or locations. The events related in a tour may have a common event name or may have the same tour name. Merchant server 140's database 145 also may include a tour schedule indicating various dates and locations of the events.

At step 210, if the event is a tour related event, merchant server 140 may determine admission cost for each event in the tour for comparison. For example, merchant server 140 may determine events in the tour that are still yet to occur. Merchant server 140 may search for available admission tickets for these events in the same tour. In an embodiment, merchant server 140 may compare prices of tickets for similar seats among the different events. Prices for seats in comparable sections of different event venues may be compared. In an embodiment, average price for comparable sections of different event venues may be determined and compared. As different event venues may have different seating arrangements and layouts, distances from various seats to the performance or the event stage may be used to find comparable seats. For example, prices for seats that are about 100 to 200 yards from a basketball court may be compared among the different events.

In an embodiment, user 105 may set a preference on what kind of tickets user 105 is interested in comparing. For example, user 105 may set up a profile indicating that ticket prices for center balcony seats are to be selected and compared among different events in a tour. In still another embodiment, user 105 may select the type of seats from each event venue in the tour for price comparison. For example, merchant server 140 may store seating maps for different event venues in the tour. The seating maps may be presented to user 105 along with available seats. User 105 may select which seat or seats are to be used for price comparison. Thus, user 105 may select seats from each event venue in the tour to compare admission costs among the different events in the tour. The admission cost may include respective tax and/or fees charged by different state or local governments.

At step 212, merchant device 140 may determine travel cost from user's location to each event in the tour. In particular, different modes of travel may be considered for traveling to each event including by foot, car, bus, train, airplane, boat/ferry, and the like. In an embodiment, user 105 may set preferences for different modes of travel based on distances to the events. For example, user 105 may prefer driving if the event is within 200 miles from user 105 and may prefer flying if the event is more than 200 miles from user 105. Other preferences for air travel, such as preferred airlines, preferred class of seating, preferred airports, preferred time of travel, and the like also may be designated by user 105. Merchant device 140 may estimate travel cost for each event based on the user's travel preferences.

Merchant device 140 may access or connect to an online travel service provider, such as an online portal for searching, browsing, and purchasing airplane tickets, hotel reservations, rental car reservations, and the like. Merchant device 140 may interact with the Application Programming Interface (API) of one or more of the online travel portals to find prices or costs for various airplane tickets, car rental prices, public transportation prices, and the like. Based on user 105's preferences, merchant device 140 may search for flights from preferred airlines for preferred class at preferred airports and at preferred travel time. In an embodiment, merchant device 140 may access user 105's calendar or schedule to determine when user 105 is available for travel. In particular, based on user 105's calendar, merchant device 140 may determine which event user 105 is able to attend and which date or time user 105 can travel by which mode of transportation to attend the event so that the user can still meet any prior scheduled commitments.

If the travel includes self-driving, merchant device 140 may estimate the cost of driving based on current gas prices. For example, merchant device 140 may look up the price of gas near user 105's location or along the driving route from user's location to the event. In another embodiment, merchant device 140 may predict or infer the price of gas at or near the date when user 105 will be driving to the event. The price of gasoline may be predicted based on historical trends or the like. For estimating driving cost, other costs such as wear and tear to the car, parking, toll fees, and other costs related to driving also may be included.

For estimating air travel cost, merchant device 140 also may estimate the transportation costs to and from the airport, such as car rental, taxi, bus, shuttle, parking, and the like. Other modes of transportation, such as by train, bus, subway, metro trains, shuttle, taxi, ferry, and the like also may be considered. Merchant device 140 may search for available modes of transportation near user 105's location and the event to find appropriate modes of transportation to various events in the tour. The estimated travel cost may include costs for multiple modes of transportation.

At step 214, merchant device 140 may estimate lodging cost for each event. In particular, merchant device 140 may determine whether lodging is needed for the event based on estimated travel arrangement or event schedule. If the event is a multi-day event, then user 105 may need to stay near the event during the multiday event. Further, if the travel schedule does not allow user 105 same day travel to and back from the event, then user 105 may need to stay along the travel route or near the event. Thus, merchant device 140 may determine possible locations for lodging based on the estimated travel plan and/or event schedule.

Lodging options may be determined based on user's preferences and availability of lodging. User 105 may set up lodging preferences such as, type of lodging, rating/star level of lodging, distance from the event, preferred per night cost range, amenities offered, such as internet access, pool, user ratings, room type, or the like. Thus, merchant device 140 may search for various lodging options near the event or along the travel route based on user 105's lodging preferences. Merchant device 140 may interact with the API's of one or more online travel portals to find prices of various lodging options. Merchant device 140 may present the lodging options on a map to show the locations of various lodging options in relation to the location of the event.

Referring back to step 206, if the event is not tour related, then merchant device may estimate the overall cost of attending the one event including admission cost, travel cost, and lodging cost by performing similar steps as 210-214, but for just one event. Thus, an overall cost may be presented to user 105 for the non-tour related event.

At step 216, merchant device 140 may determine whether the request for event information includes group consideration. For example, user 105 may be looking to purchase tickets to the tour event for a group of friends. If user 105 is looking for tickets for a group, then the request may include group consideration. In another example, if user 105 and other users associated with user 105 are looking to attend the same tour event, then the request may include group consideration. Other users associated with user 105 may be determined based on user 105's social network or contact lists. In an embodiment, merchant device 140 may provide an interface, such as a chat room or a video/audio conference, by which a group of individuals may communicate in real time to plan a trip to an event. The interface may allow users in the group to discuss, compare/contrast, negotiate, and decide which event in the tour to attend.

At step 218, if there is no group consideration, merchant device 140 may present the estimated overall cost for attending each event in the tour to user 105. As such, user 105 may decide which event from the series of tour events is the most cost effective by comparing admission cost, traveling cost, lodging cost, and other costs. For example, ticket costs may be less at an event location that requires train or plane transportation, such that the total costs associated with an event farther away from the user may end up being less costly. Moreover, descriptions regarding the location and time of the event, special features unique to each event, such as the layout of the stadium, other related events near the stadium, other amenities, also may be presented to user 105. Thus, user 105 may consider other non-monetary factors of each event besides monetary cost.

If the request includes group consideration, merchant device 140 may determine comprehensive cost for each individual in the group for attending each event in the tour. For example, if user 105 is planning to attend an event tour with a group of user 105's friends, comprehensive cost analysis may be performed for each person in the group with respect to each event in the tour. If the group includes individuals located at different places, cost estimate may be performed for traveling from these different places to each event in the tour. Group preferences also may be entered by user 105 or the group, such as carpooling, shared hotel rooms, and the like. Thus, group preferences may be included in the overall cost estimate.

A comparison table, such as a person v. event table, with each cell containing the estimated cost for each event/person combination may be used to compare cost for each person and each event. After the cost for each individual attending a respective event is determined, merchant device 140 may recommend an event which results in the lowest overall cost as a group. For example, estimated cost for each individual may be aggregated for each event to determine which event has the lowest aggregated cost for the group. In an embodiment, an event may be selected such that costs are balanced among the individual in the group. For example, an event may be selected such that the cost differences between individuals are minimized.

At step 222, the comprehensive cost for each individual with respect to each event in the tour may be presented to the group. For example, a comparison table may be presented to the group showing cost for each individual with respect to each event. Merchant device 140 may access each individual's calendar to determine events that each individual is available to attend. As noted above, a communication tool may be provided to facilitate real time communication for the group to discuss and decide which event in the tour to attend. In an embodiment, a map may be presented indicated locations of each individual and the locations of each event in the tour. Thus, users may visualize traveling routes of each individual to each event in the tour. Each traveling route may be labeled with the cost for that traveling route. Thus, users may visualize cost along with the various traveling routes.

In an embodiment, routes along the way or the final destination of the event may be analyzed to determine whether the user has friends or relatives along the route or final destination. In particular, travel or lodging costs may be reduced by staying with friends or family, share meals at friends' or family's house, share costs of the travel for picking up someone along the way, additional incentives to visit family or friends while attending the event, or having family or friends attend the event together. Thus, the system may take into consideration of user 105's non-monetary factors when estimating cost. The system may inform user 105 of these non-monetary factors and may allow user 105 to select an event based on both monetary cost and non-monetary factors.

By using the above process 200, comprehensive cost and/or value estimation including admission cost, travel cost, and lodging cost may be performed for each event in a tour. Further, if group consideration is included, cost estimation among different individuals with respect to each event in the tour may be considered as a group to minimize cost of the group or to balance cost among individuals in the group. Thus, users may be presented with comprehensive information to select an event from a series of tour events that provides the most cost saving for a user or a group,

The following is an exemplary scenario in which the above process 200 may be implemented.

### EXAMPLE 1

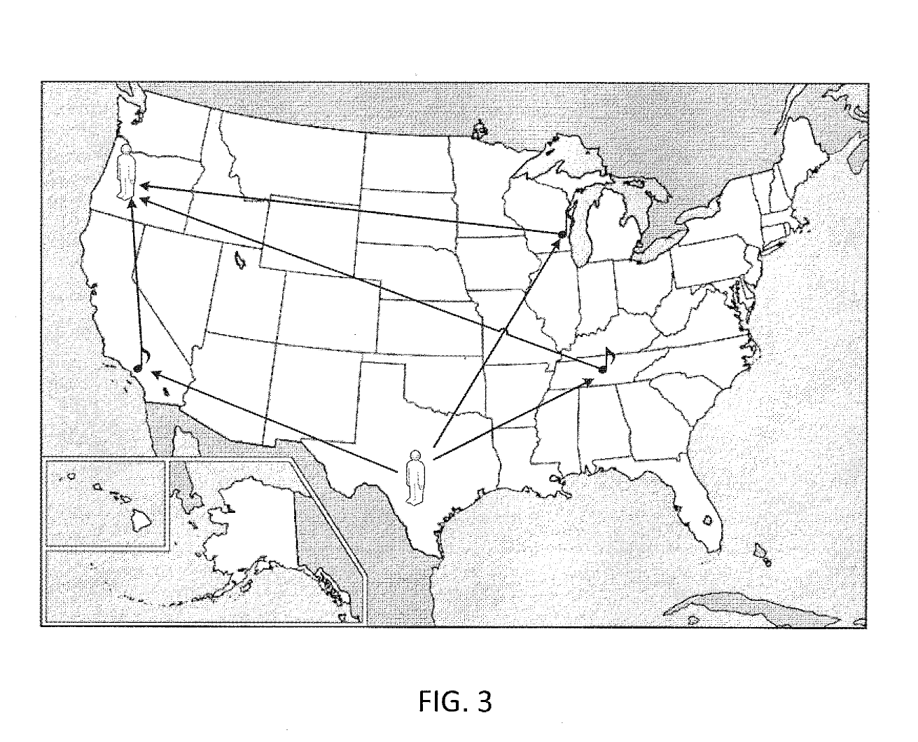

A user enjoys popular music. The user installs a ticket purchase application at the user's cell phone from the ticket exchange service provider and uses the ticket purchase application to purchase tickets for music concerts. The user's favorite artist is having a concert tour at various cities across the U.S. this year. As shown in FIG. 3, a map of the U.S. is provided which includes locations of the user and cities where the artist is having the tour events. Further, the location of the user's friend who is interested in attending the concert also is included. The user is located in Austin, Tex. and the user's friend is located in Portland, Oreg. The tour events that are available are located in Los Angeles, Calif., Chicago, Ill., and Nashville, Tenn..

The user first enters the name of the artist or the name of the tour at the ticket purchase application. The application searches for events that match the artist's name or the tour name. The application determines that there are three matching concerts that are related to a tour. The application then determines that the concerts are held at LA, Chicago, and Nashville. The user also enters the number of tickets needed and the location of the user and the user's friend. Thus, the application determines that the events are tour related and that the ticket purchase needs group consideration.

The application performs comprehensive cost analysis or estimate for the user and the user's friend to each concert. The application first determines which concerts they both are available to attend based on their respective calendars. The user and the user's friend may both be available to attend all of these three concerts. The application then estimates the admission cost, travel cost, and the admission cost for the user and the user's friend to attend each concert. The application looks up ticket prices for each of the concerts for seat sections preferred by both the user and the friend.

Based on the user's travel preference, the application determines that each of the three concerts are far away from the user's location in Austin and that air travel is needed to attend the concerts. Thus, the application connects to API's of travel portals to look up prices for plane tickets from Austin Tex. to Nashville, Chicago, and LA around the respective concert dates. The application also looks up prices for plane tickets from Portland to these three concert cities around the concert dates. In particular, the application notes that the friend may be willing to drive from Portland to LA and estimates the driving cost for the friend from Portland to LA.

The application also determines that the friend and the user may need overnight stay at the respective concert cities. The application then search for hotels that are rated three stars or above near or at the concert cities. The friend and the user are willing to share a room to save cost. Thus, the application searches for prices for two-person rooms at hotels near the concert cities. The application also determines that public transportation is available from the Chicago airport to the hotel or the concert. Thus, cost for public transportation is estimated for Chicago. The application determines that rental cars are needed to travel from airports in LA and in Nashville to the final destination, such as the concert location or the hotel. The user and the user's friend also agree to share a car or carpool. Thus, the cost for one rental car is estimated for the concerts in LA and Nashville.

The travel costs, hotel costs, and admission costs for each concert location is determined and presented to the user and the friend. The user and the friend may discuss the concert trip in a chat room provided by the application. They may agree to select the concert that results in the lowest aggregate cost for both of them. For example, they may agree to attend the concert in Nashville, Tenn., because the total price of plane tickets to Nashville for the user and the friend is the lowest compared to the plane tickets to Chicago or LA. Further, they may carpool to the hotel. In another example, they may agree to select the concert that results in balanced cost between the user and the friend. For example, they may agree to attend the concert in Chicago because their respective travel costs are similar. Thus, the application allows a group of users to estimate the overall cost for attending each concert in a concert tour. The group may select a concert from the tour to attend based on their preferences.

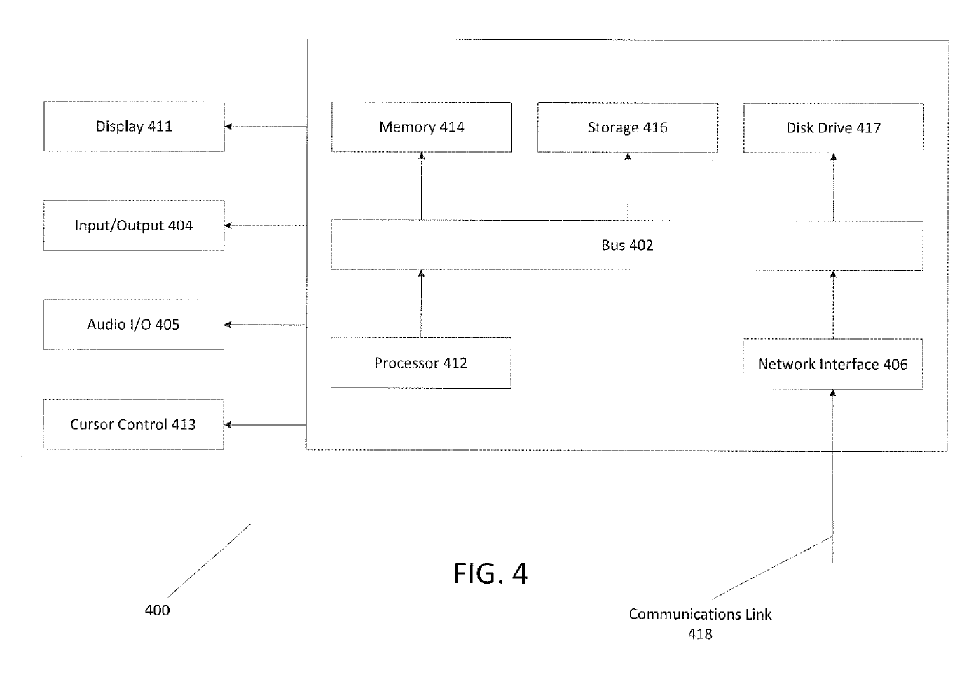

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing information about event preferences of a user, and
one or more processors in communication with the memory and adapted to:
determine a plurality of events related to a tour and held at various locations; and
estimate, for each of the events in the tour, an overall cost of attendance for the user; and
present each overall cost for attending each of the events in the tour to the user for comparison.

2. The system of claim 1, wherein the overall cost of attendance comprises one or more of an admission cost, a travel cost, and a lodging cost.

3. The system of claim 2, wherein the travel cost includes cost related to a plurality of transportation modes including one or more of an airplane, a rental car, a taxi, a bus, a train, and a ferry.

4. The system of claim 3, wherein the transportation modes are selected based on a travel preference of the user.

5. The system of claim 3, wherein the transportation modes are selected based on a distance between a location of the user and a location of the event.

6. The system of claim 2, wherein the admission cost is determined based on a seating preference of the user at each event.

7. The system of claim 2, wherein the lodging cost is determined based on a lodging preference of the user indicating a preferred category of lodging options.

8. The system of claim 1, wherein one or more of the events in the tour are selected based on the user's availability determined from a calendar of the user.

9. A method comprising:
determining, by a processor of a ticket exchange server, a plurality of events related to a tour and held at various locations; and
estimate, by the processor, for each of the events in the tour, an overall cost of attendance for a group including users located at different locations; and
present each overall cost for attending each of the events in the tour to the group for comparison.

10. The method of claim 9, wherein the overall cost of attendance comprises one or more of an admission cost, a travel cost, and a lodging cost.

11. The method of claim 9, wherein each overall cost is presented in an event v. user comparison table listing an overall cost for each user v. event combination.

12. The method of claim 9 further comprising presenting a map including locations of the users in the group and locations of the events in the tour.

13. The method of claim 9 further comprising providing, along with the presented overall cost, a communication tool configured to implement real time communication between the users in the group.

14. The method of claim 10, wherein the travel cost or the lodging cost are determined based on a group preference for sharing means of travel or lodging.

15. The method of claim 9 further comprising determining an overall cost for the group for each event in the tour by aggregating the overall costs of the users for each event.

16. The method of claim 9 further comprising:
selecting an event in the tour that results in a minimum aggregate overall costs for the group; and
recommending the selected event to the group.

17. The method of claim 9 further comprising:
selecting an event in the tour that has a balanced overall cost among the users in the group; and
recommending the selected event to the group.

18. A non-transitory computer-readable medium comprising instructions which, in response to execution by a computer system, cause the computer system to perform a method comprising:
determining a plurality of events related to a tour and held at various locations;
estimating, for each of the events in the tour, an overall cost of attendance for a user; and
presenting each overall cost for attending each of the events in the tour to the user for comparison.

19. The non-transitory computer-readable medium of claim 18, wherein the method further comprises:
selecting an event in the tour that results in a minimum overall cost for the user; and
recommending the selected event to the user.

20. The non-transitory computer-readable medium of claim 18, where the method further comprises determining an admission cost, a travel cost, and a lodging cost for attending each of the events in the tour.
